(19) United States
(12) Patent Application Publication
(10) Pub. No.: US 2020/0164495 A1
(43) Pub. Date: May 28, 2020

(54) Torque Control Device for an Electric Screwdriver

(71) Applicant: Te-Huang Wang, New Taipei City (TW)

(72) Inventor: Te-Huang Wang, New Taipei City (TW)

(21) Appl. No.: 16/687,796

(22) Filed: Nov. 19, 2019

(30) Foreign Application Priority Data
Nov. 27, 2018 (TW) 107142229

(51) Int. Cl. B25B 23/147; B25B 21/00; B23P 19/06; G01L 5/24; G05D 17/02

(52) U.S. Cl. CPC B25B 23/147; B25B 21/00; G05D 17/02; G01L 5/24; B23P 19/066

(57) ABSTRACT

A torque control device for an electric screwdriver connected to a tool head has a driving case, a transmission module, a torsion sleeve and multiple strain gauges. The tool head is connected to a front end of the driving case. The transmission module is mounted in the driving case and is capable of rotating the tool head relative to the driving case. The torsion sleeve connects the driving case and the transmission module. The driving of the transmission module can deform the torsion sleeve. The strain gauges are mounted on the torsion sleeve and are capable of detecting and recording the deformation of the torsion sleeve. By installing the strain gauges in the electrical screwdriver, working data of the electrical screwdriver can be recorded thoroughly. Torque of each fastening process can be controlled accurately according to the recorded data. Therefore, precision and efficiency of the fastening process is improved.

### BACKGROUND OF THE INVENTION

### 1. Field of the Invention

The present invention relates to a structural improvement of a hand tool, especially to a torque control device of a screwdriver.

### 2. Description of the Prior Arts

An electric screwdriver is a hand tool used for fastening and unfastening fasteners such as screws or bolts. Screws or bolts can be quickly fastened to or unfastened from a surface of a workpiece.

A conventional electric screwdriver has a torque adjusting mechanism because torque of the electric screwdriver needs to be adjusted properly according to conditions such as material and hardness of the workpiece surface and strength of the screw. Without properly adjusted torque, the surface of the workpiece or the structure of the screw may be damaged due to excessive torque, or the screw may not be fastened securely to the surface of the workpiece due to insufficient torque.

With reference to FIG. 9, to be precise, an operating process of the conventional electric screwdriver 90 adopted in a factory is as follows: after the electric screwdriver 90 is plugged in and activated by a user, a control board inside the electric screwdriver 90 is triggered, thereby making a motor rotate together with a gearbox. The gearbox is also connected to the torque adjusting mechanism, from which an upper limit of the torque of the electric screwdriver 90 can be set. The gearbox is further connected to a mechanical brake which is connected to an output shaft assembly. Said output shaft assembly is a tool head of the electric screwdriver 90.

When the torque of the electric screwdriver has reached the upper limit, the mechanical brake is triggered and a signal is sent back to the control board to stop the rotation of the motor, thereby stopping the whole operation process. However, the conventional electric screwdriver has the following shortcomings:

First, with reference to FIG. 9, the torque adjusting mechanism of the conventional electric screwdriver 90 has a spring 94 and multiple steel balls (not shown in figures) mounted inside a case of the electric screwdriver 90. Torque limiting is achieved by adjusting abutting forces between the spring 94 and the steel balls. More precisely, after the output torque of the electric screwdriver 90 has reached a limit previously defined by the user, the steel balls inside the case jump off and make the motor disconnect from the spring 94. The motor then runs freely, which informs the user that the torque has reached the previously defined limit.

However, to adjust the defined torque limit, the electric screwdriver 90 needs to be taken away from the assembly line to a specialized adjusting device for increasing or decreasing tension of the spring 94. The adjustment of the torque limit cannot be manually and timely adjusted, which is very inconvenient. Another reason that the torque limit cannot be adjusted manually is to prevent error caused by manual adjustment.

Second, in order to reduce frequency of adjusting the torque limit during working process, the user often has to prepare multiple electric screwdrivers 90 with different torque limit settings before working on the workpiece, which increases cost.

Third, the precision of torque limiting achieved by abutting forces between components such as the spring 94 and the steel balls deteriorates with time due to structural deformation or fatigue caused by continuous friction and abutting forces. As a result, the user cannot precisely adjust the electric screwdriver 90 to reach a desired torque limit.

Fourth, to conform to the concept of industry 4.0, tools for a next generation factory should be able to detect, record and adjust data of the tools anytime. In other words, sensors that are capable of detecting working conditions of the tools should be integrated into the tools. However, a conventional electric screwdriver 90 lacks the essential structure that is capable of converting the working conditions into data, and therefore is unable to record the data in each of the working processes.

As aforementioned, the conventional electric screwdriver needs to be improved.

To overcome the shortcomings, the present invention provides a torque control device for an electric screwdriver to mitigate or obviate the aforementioned problems.

### SUMMARY OF THE INVENTION

The main objective of the present invention is to provide a torque control device for an electric screwdriver. A deformation sensing module capable of detecting an extent of torsional deformation is mounted inside the torque control device, through which electrical information corresponding to the torsional deformation is generated, and the torque of the electric screwdriver can be automatically adjusted by a computer.

The torque control device is adapted to connect a tool head, and has a driving case, a transmission module, a torsion sleeve, at least one strain gauge and a rotation bearing. Two opposite ends of the driving case are respectively a front end and a rear end. The front end of the driving case is adapted to connect the tool head. The transmission module is mounted in the driving case and is capable of driving the tool head to rotate relative to the driving case. The torsion sleeve is mounted in the driving case, and connects the driving case and the transmission module. The torsion sleeve is deformable by the driving of the transmission module. The at least one strain gauge is mounted on the torsion sleeve. Each one of the at least one strain gauge is capable of detecting and recording deformation of the torsion sleeve.

The advantage of the present invention is that, by mounting the strain gauge on the torsion sleeve and detecting the deformation of the torsion sleeve using the strain gauge, detecting and recording of the deformation are thereby carried out. Meanwhile, torque detected by the strain gauge is then sent to a centralized control computer. When the torque applied on the torsion sleeve reaches a previously defined upper limit, the motor generating the torque can be automatically stopped, which achieves the same efficacy as the conventional electric screwdriver with springs and steel balls does.

Meanwhile, the user is able to identify precise torque and other related working data each time the electric screwdriver operates, from which the user can perform customized adjustment for different working conditions and improve the fastening function. On the other hand, by transmitting the data, the torque of the electric screwdriver can be controlled by computer, which means the torque of the electric screwdriver can be adjusted by the computer before fastening each screw, thereby improving working efficiency and saving cost. Finally, because the deformation of the torsion sleeve is minute, the torsion sleeve does not have to sustain frequent and enormous abutting pressure like a conventional spring and steel balls do each time the electric screwdriver operates. As a result, durability of the present invention is excellent.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a torque control device for an electric screwdriver in accordance with the present invention;

FIG. 2 is an exploded view of the torque control device for an electric screwdriver in FIG. 1;

FIG. 3 is an exploded view of a torsion sleeve and a signal sensing module of the torque control device for an electric screwdriver in FIG. 1 in partial section;

FIG. 4 is a sectional view of the torque control device for an electric screwdriver in FIG. 1;

FIG. 5 is a sectional view in partial section of the torsion sleeve of the torque control device for an electric screwdriver in FIG. 1;

FIG. 6 is a perspective view of the torsion sleeve of the torque control device for an electric screwdriver in FIG. 1, showing a different status of the torque control device;

FIG. 7 is an exploded view of the torque control device for an electric screwdriver in FIG. 6;

FIG. 8 is a sectional view of the torque control device for an electric screwdriver in FIG. 6; and

FIG. 9 is an exploded view of a conventional torque control device for an electric screwdriver.

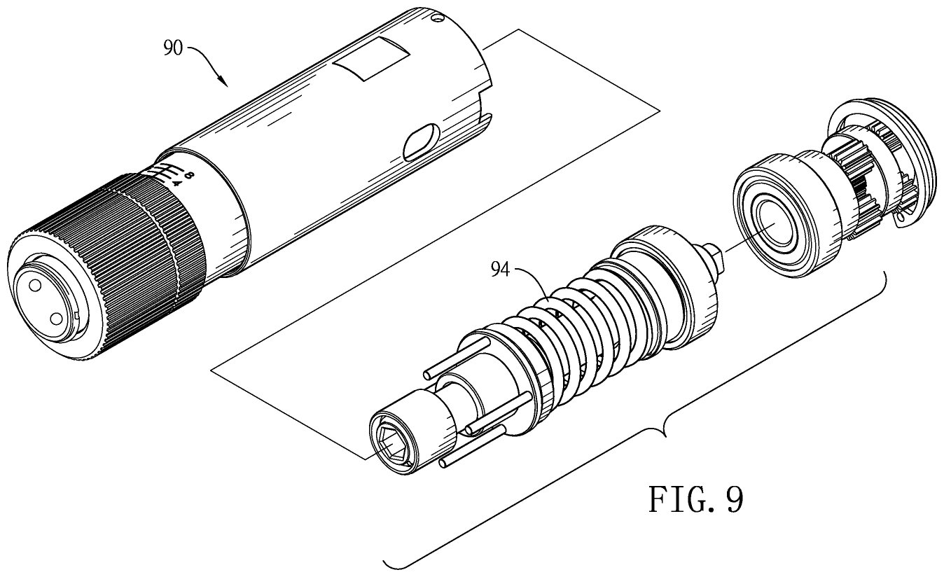

### DETAILED DESCRIPTION OF THE PREFERRED EMBODIMENTS

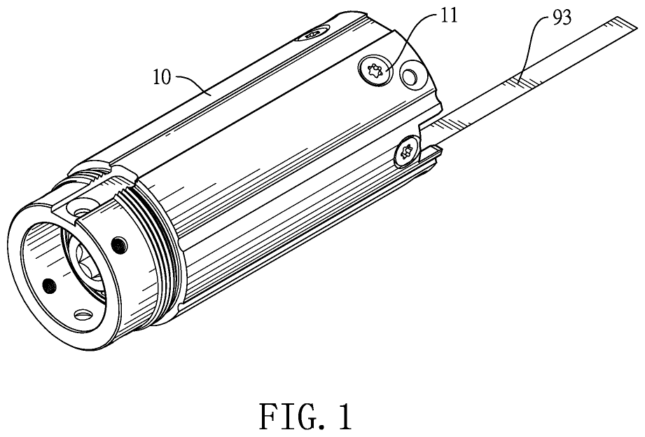

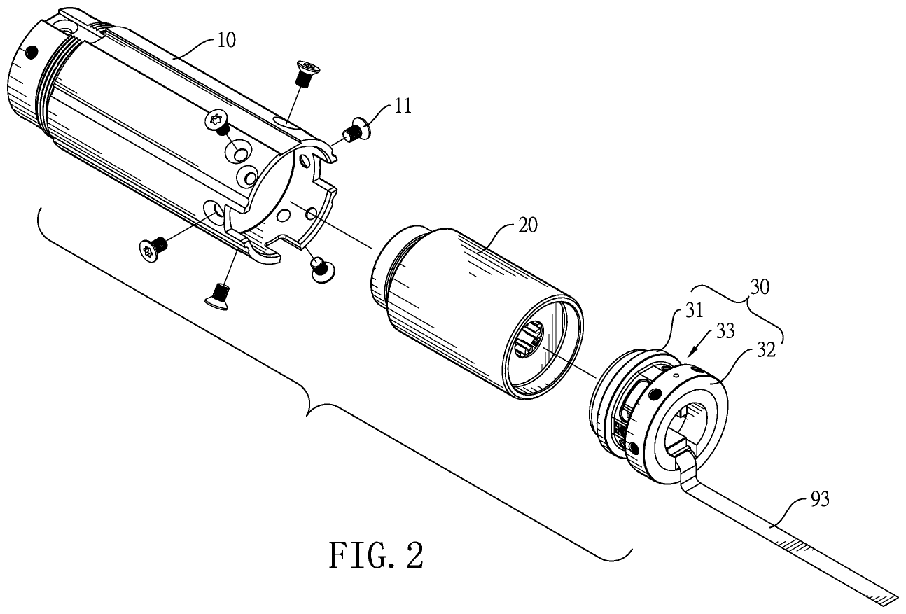

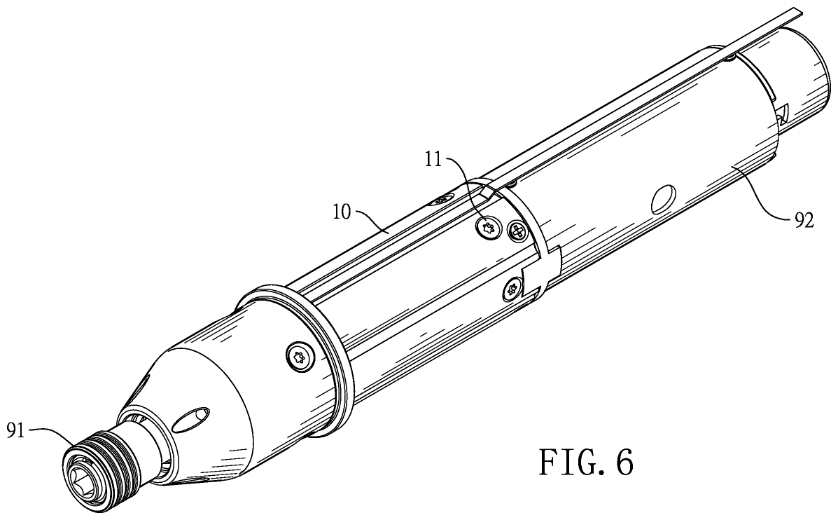

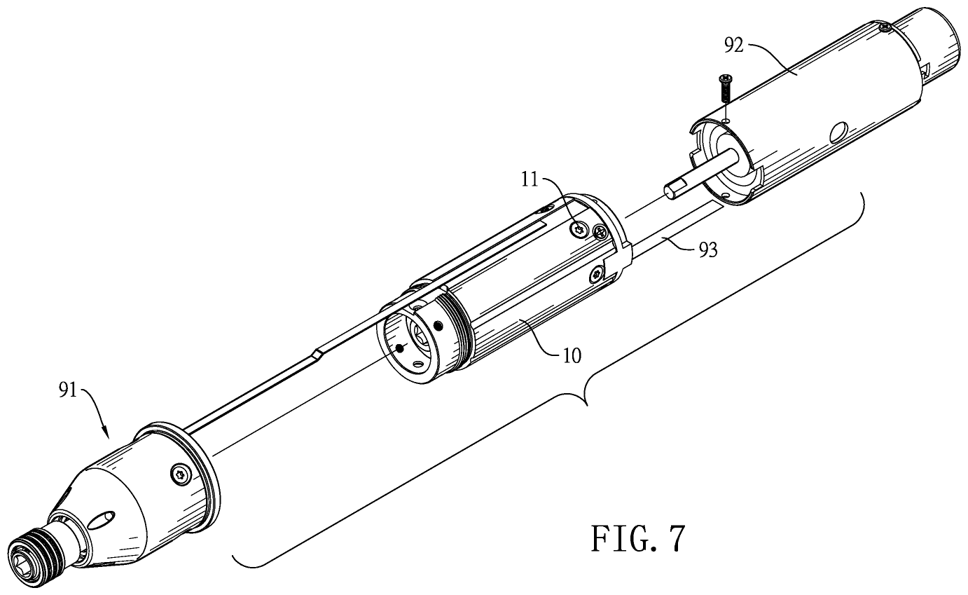

With reference to FIGS. 1, 6, and 7, a torque control device for an electric screwdriver in accordance with the present invention is adapted to connect a tool head 91 and a motor 92. The tool head 91 and the motor 92 are respectively mounted at a front end and a rear end of the present invention. With further reference to FIGS. 2, 3, and 4, the present invention comprises a driving case 10, a transmission module 20, a torsion sleeve 30, at least one strain gauge 40 and a rotation bearing 50.

With reference to FIGS. 2, 4, and 8, two opposite ends of the driving case 10 are respectively a front end and a rear end. The front end of the driving case 10 is adapted to connect the tool head 91. The transmission module 20 is mounted in the driving case 10, and is capable of driving the tool head 91 to rotate relative to the driving case 10. In a preferred embodiment, the transmission module 20 is a planetary gear set.

With reference to FIGS. 2, 3, and 8, the torsion sleeve 30 is mounted in the driving case 10 and connects the driving case 10 and the transmission module 20. In a preferred embodiment, said transmission module 20 is, mounted between the tool head 91 and the torsion sleeve 30, but it is not limited thereto. Moreover, in a preferred embodiment, a shape of the torsion sleeve 30 is cylindrical, but the shape of the torsion sleeve 30 is not limited thereto.

With reference to FIGS. 2, 3, and 5, the torsion sleeve 30 is deformable by the driving of the transmission module 20, and to be precise, in a preferred embodiment, a front end of the torsion sleeve 30 is fixed to a ring gear (not shown in figures) of the transmission module 20. A rear end of the torsion sleeve 30 is fastened to an interior of the driving case 10. When the torque applied on the planetary gear set has reached a per-defined value, a sun gear of the planetary gear set can no longer rotate the ring gear, which in turn makes the ring gear twist the front end of the torsion sleeve 30. Because the rear end of the torsion sleeve 30 is fixed by the driving case 10, the twist from the ring gear results in a torsional deformation between the front end and the rear end of the torsion sleeve 30.

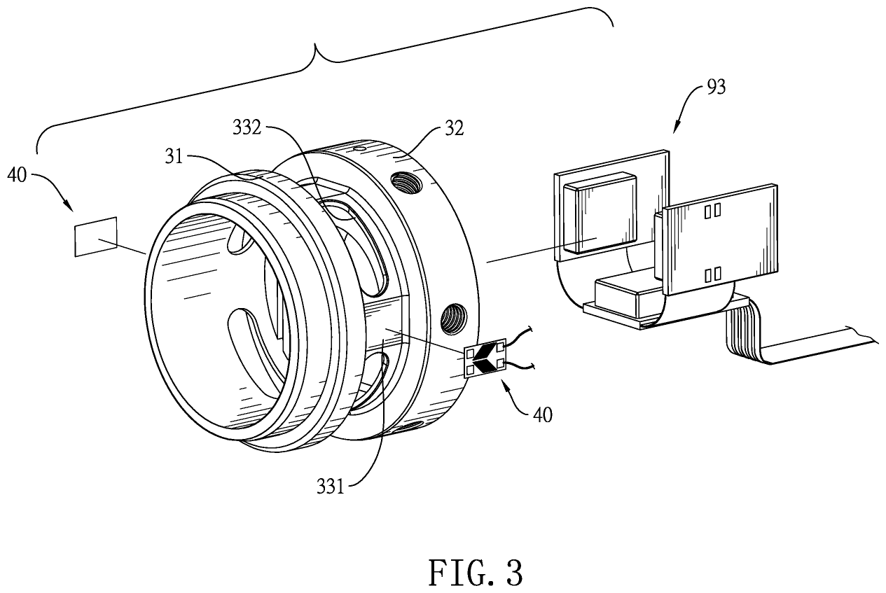

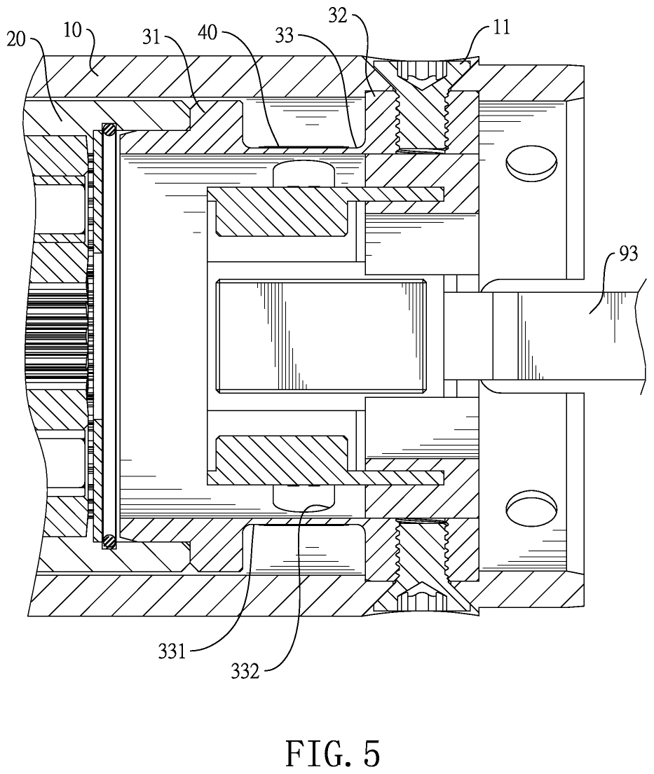

With reference to FIGS. 3 and 5, the torsion sleeve 30 has a front connecting portion 31, a rear connecting portion 32 and a gauging portion 33. The front connecting portion 31 is located behind the transmission module 20. The rear connecting portion 32 is located behind the front connecting portion 31. The gauging portion 33 is located between the front connecting portion 31 and the rear connecting portion 32, and the two opposite ends of the gauging portion 33 are respectively connected to the front connecting portion 31 and the rear connecting portion 32.

With reference to FIG. 5, to be more precisely, in a preferred embodiment, the torsion sleeve 30 is a cylindrical sleeve with a through hole formed through two opposite ends of the sleeve. A thickness of the gauging portion 33 is smaller than a thickness of the front connecting portion 31, and a thickness of the gauging portion 33 is smaller than a thickness of the rear connecting portion 32. The gauging portion 33 has a gauging wall 331 and multiple elongated holes 332, and said thickness of the gauging portion 33 refers to a thickness of the gauging wall 331. The elongated holes 332 are formed through the gauging wall 331 and disposed apart from each other. The elongated holes 332 extend along a circumference of the gauging wall 331.

With reference to FIG. 3, the at least one strain gauge 40 is mounted on the torsion sleeve 30 and is capable of detecting and recording the deformation of the torsion sleeve 30. In a preferred embodiment, the at least one strain gauge 40 includes a plurality of strain gauges 40. The strain gauges 40 are mounted on an outer surface of the gauging portion 33, and to be precise, each one of the strain gauges 40 is mounted between two adjacent ones of the elongated holes 332, and thus the elongated holes 332 and the strain gauges 40 are arranged on the gauging wall 331 in a staggered manner.

On the other hand, when the present invention is under an operating status, the strain gauge 40 is electrically connected to a signal sensing module 93, and the data recorded by the strain gauge 40 is transmitted through the signal sensing module 93 to an external computer. In a preferred embodiment, the signal sensing module 93 is located inside the torsion sleeve 30, but the location of the signal sensing module 93 is not limited thereto.

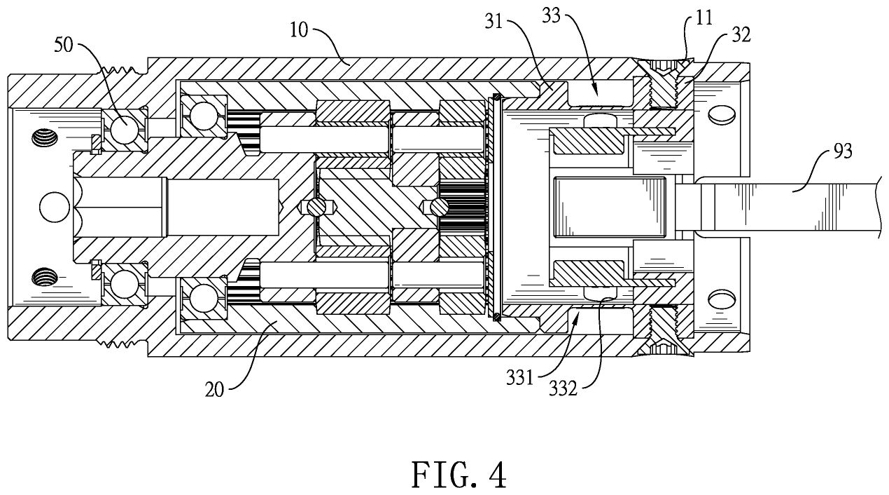

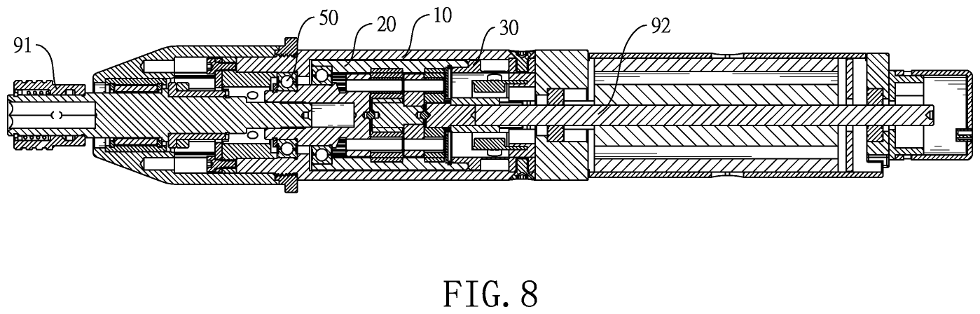

With reference to FIGS. 4 and 8, the rotation bearing 50 is mounted in the driving case 10. The rotation bearing 50 is mounted around the transmission module 20 and disposed apart along a lengthwise direction of the transmission module 20. An inner surface of the rotation bearing 50 is attached to the transmission module 20, and an outer surface of the rotation bearing 50 is attached to an inner surface of the driving case 10.

Operating statuses and advantages of the present invention are as follows:

With reference to FIGS. 2, 3, and 7, when the present invention is under the operating status, the present invention is electrically connected to an external computer (not shown in figures) via the signal sensing module 93, and an upper limit of torque transferred by the motor 92 is set by the computer. The signal sensing module 93 can simultaneously transmit data related to brake, working process, and counter.

To operate the electric screwdriver, the user activates the electric screwdriver, makes the motor rotate, and fastens a bolt or screw using the rotation of tool head 91. As the bolt is gradually fastened into the workpiece, torque gradually transfers from the tool head 91 to the torsion sleeve 30, thereby deforming the torsion sleeve. The deformation is then recorded by the strain gauge 40 and transmitted through the signal sensing module 93 to the external computer. When the value recorded by the strain gauge 40 reaches the value previously defined by the user, the computer stops the rotation of the motor 92, thus stopping the electric screwdriver and completing the whole operation.

The advantage of the present invention is as follows:

First, with reference to FIG. 3, by mounting the strain gauge which is capable of detecting and recording extent of deformation, the present invention is able to record data each time the electric screwdriver operates, from which conditions of each working process such as working result and error can be determined and integrated. By collecting and analyzing these data, the present invention can further pair with other facilities inside the factory to achieve industry 4.0.

Second, with feedback of the torque readings, torque of each electric screwdriver can be controlled by the user through the computer. In other words, the torque of each electric screwdriver can be adjusted each time the electric screwdriver operates according to properties of the workpiece, which improves quality. Meanwhile, the torque limit of each electric screwdriver can be adjusted quickly and directly by the computer, meaning the user operating the electric screwdriver no longer has to prepare multiple electric screwdrivers with different torque limits.

Third, with reference to FIGS. 2 and 3, using the torsion sleeve 30 reduces wear of the electric screwdriver during operation, and thereby improves service life of the electric screwdriver.

To sum up, the present invention effectively improves accuracy, service life and working efficiency.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A torque control device for an electric screwdriver, the torque control device adapted to connect a tool head and comprising:
a driving case, two opposite ends of the driving case being respectively a front end and a rear end; the front end of the driving case adapted to connect the tool head;
a transmission module mounted in the driving case and capable of driving the tool head to rotate relative to the driving case;
a torsion sleeve mounted in the driving case and connecting the driving case and the transmission module; the torsion sleeve being deformable by the driving of the transmission module;
at least one strain gauge mounted on the torsion sleeve; each one of the at least one strain gauge capable of detecting and recording deformation of the torsion sleeve.

2. The torque control device as claimed in claim 1 further comprising:
a rotation bearing mounted in the driving case and around the transmission module; an inner surface and an outer surface of the rotation bearing attached to the transmission module and the driving case respectively.

3. The torque control device as claimed in claim 1, wherein the torsion sleeve has:
a front connecting portion located behind the transmission module;
a rear connecting portion located behind the front connecting portion;
a gauging portion located between the front connecting portion and the rear connecting portion; a thickness of the gauging portion being smaller than a thickness of the front connecting portion, and the thickness of the gauging portion being smaller than a thickness of the rear connecting portion; the at least one strain gauge mounted on an outer surface of the gauging portion.

4. The torque control device as claimed in claim 2, wherein the torsion sleeve has:
a front connecting portion located behind the transmission module;
a rear connecting portion located behind the front connecting portion;
a gauging portion located between the front connecting portion and the rear connecting portion; a thickness of the gauging portion being smaller than a thickness of the front connecting portion, and a thickness of the gauging portion being smaller than a thickness of the rear connecting portion; the at least one strain gauge mounted on an outer surface of the gauging portion.

5. The torque control device as claimed in claim 3, wherein
the gauging portion of the torsion sleeve has:
a gauging wall;
multiple elongated holes formed through the gauging wall and disposed apart from each other; the elongated holes extending along a circumference of the gauging wall;
each one of the at least one strain gauge is mounted between two adjacent ones of the elongated holes.

6. The torque control device as claimed in claim 4, wherein
the gauging portion of the torsion sleeve has:
a gauging wall;
multiple elongated holes formed through the gauging wall and disposed apart from each other; the elongated holes extending along a circumference of the gauging wall;
each one of the at least one strain gauge is mounted between two adjacent ones of the elongated holes.

7. The torque control device as claimed in claim 1, wherein the torsion sleeve is fastened in the driving case with multiple screws.

8. The torque control device as claimed in claim 6, wherein the torsion sleeve is fastened in the driving case with multiple screws.

9. The torque control device as claimed in claim 1, wherein the transmission module is located between the tool head and the torsion sleeve.

10. The torque control device as claimed in claim 8, wherein the transmission module is located between the tool head and the torsion sleeve.
